(19) United States
(12) Patent Application Publication
(10) Pub. No.: US 2012/0240574 A1
(43) Pub. Date: Sep. 27, 2012

(54) INTERNAL COMBUSTION ENGINE EQUIPPED WITH TWO EXHAUST-GAS TURBOCHARGERS, AND METHOD FOR OPERATING AN INTERNAL COMBUSTION ENGINE OF SAID TYPE

(75) Inventors: Rainer Friedfeldt, Huerth (DE); Bernd Steiner, Bergisch Gladbach (DE); Kai Sebastian Kuhlbach, Bergisch Gladbach (DE)

(73) Assignee: FORD GLOBAL TECHNOLOGIES, LLC, Dearborn, MI (US)

(21) Appl. No.: 13/419,058

(22) Filed: Mar. 13, 2012

(30) Foreign Application Priority Data
Mar. 25, 2011 (EP) 11159694.6

(51) Int. Cl. F02D 23/00; F02B 33/40

(52) U.S. Cl. 60/602; 60/612; 60/611

(57) ABSTRACT

Embodiments for controlling exhaust flow are provided. Example embodiments include a cylinder head having two integrated exhaust manifolds, wherein each exhaust manifold is coupled to a turbine of a turbocharger. After passing over the turbines, the exhaust gas may exit through a shared balcony-like projection arranged between the exhaust manifolds.

### RELATED APPLICATIONS

The present application claims priority to European Patent Application No. 11159694.6, filed on Mar. 25, 2011, the entire contents of which are hereby incorporated by reference for all purposes.

### FIELD

The disclosure relates to a supercharged internal combustion engine having at least two exhaust-gas turbochargers.

### BACKGROUND AND SUMMARY

Internal combustion engines have a cylinder block and at least one cylinder head which are connected to one another to form the cylinders. To control the charge exchange, an internal combustion engine requires control elements—generally lifting valves—and actuating devices for actuating the control elements. The valve actuating mechanism required for the movement of the valves, including the valves themselves, is referred to as the valve drive. The cylinder head often serves to accommodate the valve drive.

During the charge exchange, the combustion gases are discharged via the outlet openings of the cylinders, and the charging of the combustion chambers, that is to say the induction of fresh mixture or fresh air, takes place via the inlet openings. It is the object of the valve drive to open and close the inlet and outlet openings at the correct times, with a fast opening of the largest possible flow cross sections being sought in order to keep the throttling losses in the inflowing and outflowing gas flows low and in order to ensure a high level of charging of the combustion chamber with fresh air, and an effective, that is to say complete, discharge of the exhaust gases.

The outlet ducts, that is to say exhaust lines, which adjoin the outlet openings may be at least partially integrated in the cylinder head. The exhaust lines of the at least two cylinders are generally merged to form one common overall exhaust line or—as is the case in the internal combustion engine according to the disclosure—to form two or more overall exhaust lines. The merging of exhaust lines to form an overall exhaust line is referred to in general and within the context of the present disclosure as an exhaust manifold, with that part of the overall exhaust line which lies upstream of a turbine arranged in the overall exhaust line being considered according to the disclosure as belonging to the exhaust manifold.

Downstream of the manifold, the exhaust gases are in the present case supplied, for the purpose of supercharging the internal combustion engine, to the turbines of at least two exhaust-gas turbochargers, and if appropriate to one or more exhaust-gas aftertreatment systems.

An exhaust-gas turbocharger comprises a compressor and a turbine which are arranged on the same shaft. The hot exhaust-gas flow is supplied to the turbine and expands, as a result of which the shaft is set in rotation. Owing to the high rotational speeds, a plain bearing is usually provided for the shaft. The energy supplied by the exhaust-gas flow to the turbine and to the shaft is used for driving the compressor which is likewise arranged on the shaft. The compressor delivers and compresses the charge air supplied to it, as a result of which the supercharging of the cylinders is obtained. A charge-air cooling arrangement may be provided, by means of which the compressed combustion air is cooled before it enters the cylinders.

Supercharging serves primarily to increase the power of the internal combustion engine. Here, the air required for the combustion process is compressed, as a result of which a greater air mass can be supplied to each cylinder per working cycle. In this way, the fuel mass and therefore the mean effective pressure can be increased. Supercharging is a suitable means for increasing the power of an internal combustion engine while maintaining an unchanged swept volume, or for reducing the swept volume while maintaining the same power. In any case, supercharging leads to an increase in volumetric power output and an improved power-to-weight ratio. For the same vehicle boundary conditions, it is thus possible to shift the load collective toward higher loads, where the specific fuel consumption is lower.

The configuration of the exhaust-gas turbocharging often poses difficulties, because it is basically sought to obtain a noticeable power increase in all rotational speed ranges, but a severe torque drop is observed if a certain rotational speed is undershot. Said torque drop is understandable if one takes into consideration that the charge pressure ratio is dependent on the turbine pressure ratio. In the case of a diesel engine, for example, if the engine rotational speed is reduced, this leads to a smaller exhaust-gas mass flow and therefore to a lower turbine pressure ratio. This has the result that, toward lower rotational speeds, the charge pressure ratio likewise decreases, which equates to a torque drop.

Here, it would fundamentally be possible for the drop in charge pressure to be counteracted by means of a reduction in the size of the turbine cross section, and the associated increase in the turbine pressure ratio. This would however merely shift the torque drop further toward lower rotational speeds. Furthermore, said approach, that is to say the reduction in size of the turbine cross section, is subject to limits because the desired supercharging and performance increase should be possible even at high rotational speeds or in the case of large exhaust-gas quantities.

Previous approaches have sought, using a variety of measures, to improve the torque characteristic of a supercharged internal combustion engine. For example, the torque characteristic may be improved by means of a small design of the turbine cross section and simultaneous provision of an exhaust-gas blow-off facility. Such a turbine is also referred to as a wastegate turbine. If the exhaust-gas mass flow exceeds a threshold value, a part of the exhaust-gas flow is, within the course of the so-called exhaust-gas blow-off, conducted via a bypass line past the turbine. Said approach has the disadvantage that the supercharging behavior is inadequate at relatively high rotational speeds or in the case of relatively large exhaust-gas quantities.

The torque characteristic of a supercharged internal combustion engine may furthermore be improved by means of multiple turbochargers arranged in parallel, that is to say by means of multiple turbines of small cross section arranged in parallel, wherein turbines are activated with increasing exhaust-gas quantity.

The inventors herein have recognized a few issues with the above approaches. Internal combustion engines of the above types still have a multiply branched line system downstream of the turbines in order to discharge the exhaust gas from the two turbines, accumulate said exhaust gas in a common line and supply said exhaust gas to an exhaust-gas aftertreatment system.

Such a line system opposes a compact design and dense packaging. Furthermore, the lines which run on the outside adjacent to the cylinder head and cylinder block constitute a permanent heat source which may be a problem with regard to other components, in particular with regard to parts produced from plastic.

Accordingly, embodiments for a supercharged engine are provided. In one example, a supercharged internal combustion engine comprises a cylinder head with at least two cylinders in an in-line arrangement along a longitudinal axis of the cylinder head, each cylinder having at least one outlet opening for discharging exhaust gases, each said outlet opening being adjoined by an exhaust line; two integrated exhaust manifolds, each integrated into a common cylinder head, the integrated exhaust manifolds including merged exhaust lines of at least one cylinder, and possibly multiple cylinders, to form first and second overall exhaust lines within the cylinder head, each overall exhaust line emerging from the cylinder head on a side of the exhaust manifolds which faces away from the cylinders, the first and second overall exhaust lines spaced apart from one another along the longitudinal axis of the cylinder head; a first exhaust-gas turbocharger having a turbine with an inlet region connected to the first overall exhaust line; a second exhaust-gas turbocharger having a turbine with an inlet region connected to the second overall exhaust line; and a balcony-like projection which is arranged between the first and second overall exhaust lines emerging from the cylinder head, which on each of two sides of the projection which face towards the turbines, has an opening which is connected to an outlet region of the respective turbine, wherein ducts adjoining each opening merge to form a common line which emerges from the projection.

It is preferable for one turbine to be designed as an activatable turbine which is activated only in the case of relatively large exhaust-gas quantities. In comparison with embodiments in which only a single exhaust-gas turbocharger is used, the turbine cross section and the associated rotor of each of the two turbines arranged in parallel are small and lightweight respectively, which offers advantages with regard to an acceleration of the rotor.

According to the disclosure, the first overall exhaust line is connected to the inlet region of the turbine of a first exhaust-gas turbocharger, and the second overall exhaust line is connected to the inlet region of the turbine of a second exhaust-gas turbocharger.

It is basically sought to arrange the exhaust-gas turbocharger or turbines as close as possible to the outlet openings of the at least two cylinders in order thereby firstly to be able to optimally utilize the exhaust-gas enthalpy of the hot exhaust gases, which is determined significantly by the exhaust-gas pressure and the exhaust-gas temperature, and secondly to ensure a fast response behavior of the turbochargers. In this connection, it is therefore basically sought to minimize the thermal inertia and the volume of the line system upstream of the turbines, which may be achieved by reducing the mass and the length of the exhaust lines.

Expedient here is inter alia the merging of the exhaust lines within the cylinder head, that is to say the integration of the exhaust manifolds into the at least one cylinder head. The overall length and the volume of the line system upstream of the turbines are reduced. Said measure also leads to a compact design, to a reduced number of components and consequently to a reduction in costs, in particular assembly and procurement costs. The compact design furthermore permits dense packaging of the drive unit in the engine bay. An internal combustion engine in which the exhaust lines of at least two cylinders merge, to form two overall exhaust lines, within the cylinder head such that two integrated exhaust manifolds are formed is also the subject matter of the present disclosure.

According to the disclosure, the cylinder head is formed with a projection which is situated on the outlet side between the two turbines arranged on the cylinder head and which has at least three openings, two of which serve for discharging the exhaust gas from the turbines and for the accumulation of the exhaust gas, whereas a third opening serves for conducting the exhaust gas via a common line, for example to an exhaust-gas aftertreatment system.

In this way, the multiply branched line system downstream of the turbines is made obsolete, or is considerably minimized. The overall length of all the lines, and therefore also the line volume and the installation space taken up, are noticeably shortened and reduced respectively.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows a plan view of a first embodiment of the internal combustion engine.

FIG. 2 schematically shows a perspective illustration of the internal combustion engine of FIG. 1.

FIG. 3 schematically shows a plan view of a second embodiment of the internal combustion engine.

FIG. 4 schematically shows a plan view of a third embodiment of the internal combustion engine.

FIG. 5 is a flow chart illustrating a method of controlling exhaust gas according to an embodiment of the present disclosure.

### DETAILED DESCRIPTION

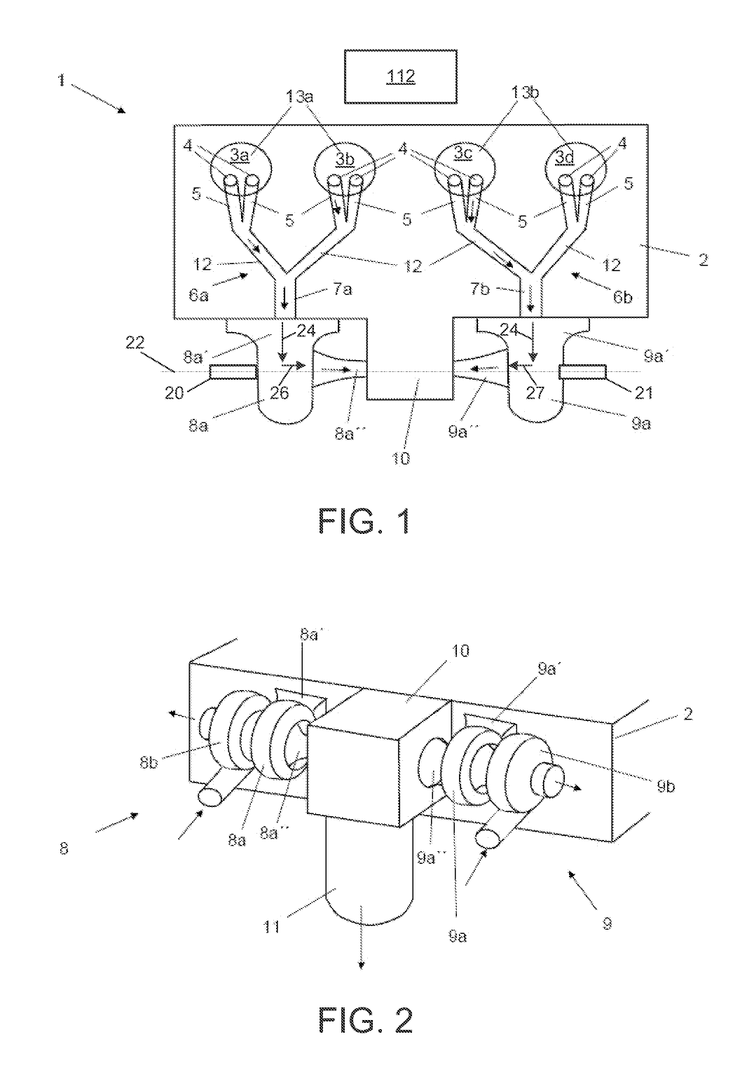

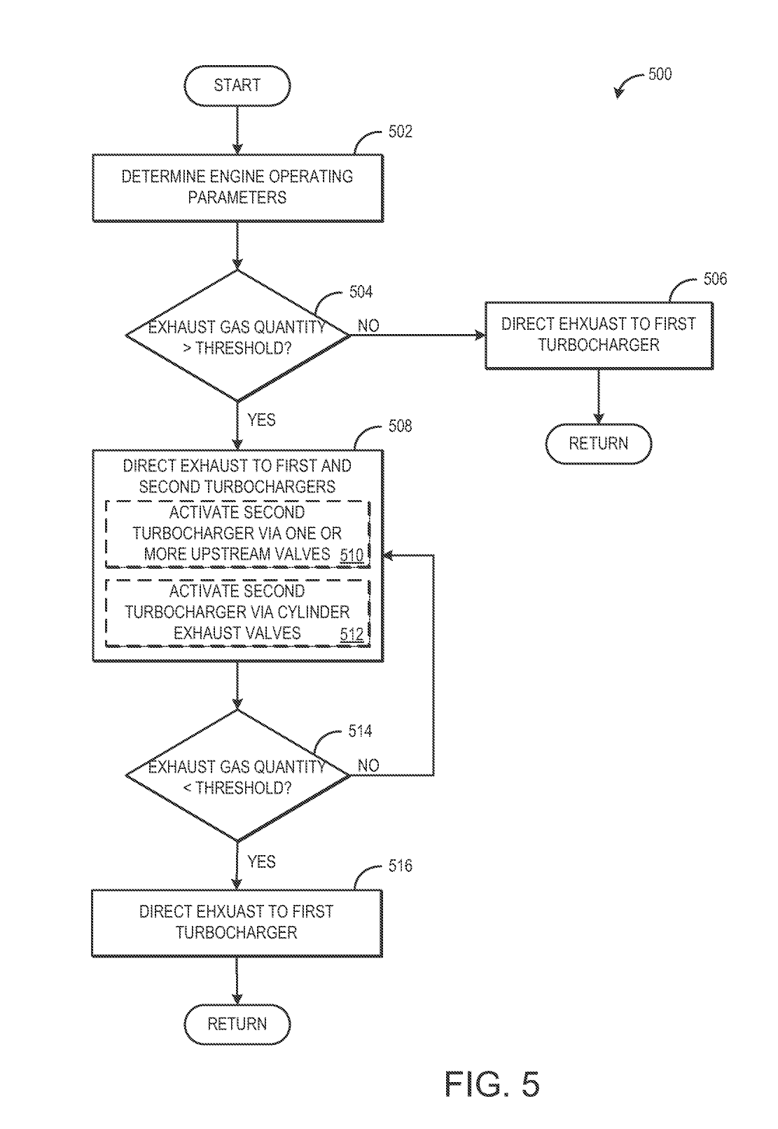

Embodiments for directing exhaust gas through multiple exhaust manifolds each coupled to a turbocharger are provided. FIGS. 1-4 are engine diagrams illustrating various example embodiments of an internal combustion engine according to the present disclosure. FIG. 5 is a flow chart illustrating an example method which may be carried by the engine of the present disclosure.

Within the context of the present disclosure, the expression “internal combustion engine” encompasses in particular spark-ignition engines, but also diesel engines and also hybrid internal combustion engines.

The line system according to the disclosure, which is characterized by the projection formed on the cylinder head, permits a compact design and dense packaging in the engine bay. The installation space taken up by the line system is comparatively small, such that design restrictions arising from the fact that the line system which is hot during operation constitutes a permanent heat source are virtually eliminated.

The line system according to the disclosure also offers advantages with regard to the exhaust-gas aftertreatment. Similarly to the situation with the turbines, it is also sought to arrange the various exhaust-gas aftertreatment systems as close as possible to the outlet of the internal combustion engine, that is to say to the outlet openings of the cylinders. The exhaust gases should be given little opportunity, that is to say time and distance, to cool down, in order that the exhaust-gas aftertreatment systems reach their operating temperature or light-off temperature as quickly as possible, in particular after a cold start of the internal combustion engine.

Whereas it is expedient with regard to the turbines to minimize the thermal inertia of the line system upstream of the turbines by reducing the mass and the length, for example by integrating the manifolds, it is—in addition to this—expedient with regard to the exhaust-gas aftertreatment to minimize the thermal inertia of the line system downstream of the turbines by reducing the mass and the length. According to the disclosure, this is achieved in that a projection is formed integrally with the cylinder head, which projection performs and includes therein functions and parts, respectively, of the required line system.

The two turbines are fastened at the inlet side directly to the cylinder head, preferably using fastening means such as screws, and are connected at the outlet side to the projection formed monolithically with the cylinder head, again preferably using fastening means such as screws.

An internal combustion engine according to the disclosure, in which the cylinders are arranged distributed on two cylinder banks may also have two cylinder heads.

According to the disclosure, the exhaust lines of all the cylinders of a cylinder head may not merge to form two overall exhaust lines; in fact, only the exhaust lines of at least two cylinders may be grouped in the described way.

Examples are however particularly advantageous in which the exhaust lines of all the cylinders of the at least one cylinder head merge to form two overall exhaust lines.

Examples of the supercharged internal combustion engine are advantageous in which the two overall exhaust lines which emerge from the at least one cylinder head have a spacing L along the longitudinal axis of the cylinder head, for which the following applies: L≧D, wherein D is the diameter of a cylinder.

The formation or arrangement of the projection belonging to the cylinder head necessitates an adequate spacing of the two turbines. A certain spacing of the two overall exhaust lines emerging from the cylinder head facilitates this, or corresponds thereto in an advantageous manner. In the case of liquid-cooled internal combustion engines, overall exhaust lines with a considerable spacing to one another facilitate the arrangement of coolant ducts or coolant jackets in the cylinder head, in particular between the two overall exhaust lines.

In the case of cylinder heads having multiple cylinders in an in-line arrangement, overall exhaust lines spaced apart from one another along the longitudinal axis of the cylinder head furthermore have an advantageous effect on the geometry of the two associated exhaust manifolds. Since no merging of the overall exhaust lines upstream of the turbines is envisaged here, each of the two overall exhaust lines may be designed or arranged so as to obtain as small a volume as possible of the exhaust manifold. The advantages of an exhaust system of said type have already been discussed in detail.

For the stated reasons, examples of the supercharged internal combustion engine are also advantageous in which the two overall exhaust lines which emerge from the at least one cylinder head have a spacing L along the longitudinal axis of the cylinder head, for which the following applies: L≦1.5 D, which in one example may include L≦2.0 D, wherein D is the diameter of a cylinder.

In the case of internal combustion engines in which the at least one cylinder head can be connected at an assembly end side to a cylinder block, examples of the supercharged internal combustion engine are advantageous in which the common line which emerges from the projection emerges on the side facing toward the assembly end side, that is to say leads in the direction of or along the cylinder block.

Said example makes allowance for the fact that, on the side facing away from the assembly end side, there are generally arranged a multiplicity of components produced from plastic, such as for example the cover of a valve drive or parts of the intake system, and the drive unit is often arranged in the vehicle directly below the engine hood, such that there is not the installation space to lead the common line along the cylinder head, if appropriate beyond the cylinder head.

It may also be taken into consideration in this context that the adjoining exhaust-gas-conducting line system runs substantially on the vehicle floor to the outlet into the environment, such that it is expedient for the common line which emerges from the projection to be conducted downward, that is to say in the direction of the vehicle floor.

Examples of the supercharged internal combustion engine are advantageous in which at least two cylinders are configured in such a way as to form two groups with in each case at least one cylinder, and the exhaust lines of the cylinders of each cylinder group merge, to form in each case one overall exhaust line, within the cylinder head such that an integrated exhaust manifold is formed.

In the present case, each overall exhaust line is supplied or acted on only with the exhaust gas of certain cylinders.

Said example allows the cylinders to be grouped or separated from one another in a suitable way, for example such that the dynamic wave phenomena in the exhaust lines of a cylinder group adversely affect one another as little as possible, for example the pressure waves propagating in the exhaust lines do not attenuate one another. In order that the cylinders combined in one cylinder group do not adversely affect one another during the charge exchange, the cylinders are preferably grouped such that the cylinders of a cylinder group have as large an offset as possible with regard to their working processes.

If an outlet opening is opened at the start of the charge exchange, the combustion gases flow at high speed through the outlet opening into the exhaust line on account of the high pressure level prevailing in the cylinder at the end of the combustion and the associated high pressure difference between the combustion chamber and the exhaust line. Said pressure-driven flow process is accompanied by a high pressure peak which is also referred to as a pre-load discharge and which propagates along the exhaust lines at the speed of sound.

With regard to the charge exchange, it is advantageous for the cylinders to be grouped in such a way that, when the at least one outlet opening of a cylinder of a group opens, the outlet openings of the other cylinders of said group are closed, or the outlet openings of the other cylinders of said group are closed at the time at which the pressure wave or the pre-load discharge of the opening cylinder arrives or is expected at the outlet opening of another cylinder. In this way, a return flow of exhaust gas through the outlet opening into the combustion chamber can be avoided.

Since the individual exhaust lines are shortened as a result of an integration of the manifold into the cylinder head, the risk of the cylinders hindering one another during the charge exchange, or of the dynamic wave phenomena in the exhaust lines of the cylinder adversely being superposed on one another, may be increased. In this respect, a grouping of the cylinders in connection with the integration of the manifold may be particularly advantageous.

A grouping of the cylinders also creates more degrees of freedom for the configuration of the control times of the valves of a cylinder, because cylinders which may possibly adversely affect one another can be separated from one another in a suitable way, specifically in such a way that the cylinders of a cylinder group have as great an offset as possible with regard to their working processes. It is thus possible for the opening times of the valves, in particular of the outlet valves, to be lengthened, or for the closing time of the outlet valves to be shifted in the late direction, without there being the risk of the charge exchange of a cylinder, in particular the pre-load discharge of a cylinder, causing a return flow of exhaust gas through the outlet opening of another cylinder into the combustion chamber. Advantages are attained with regard to efficiency and pollutant emissions.

In the case of a supercharged internal combustion engine of the type in question, in which the at least one cylinder head has at least three cylinders in an in-line arrangement, examples are advantageous in which the first cylinder group comprises the outer cylinders and the second cylinder group comprises the at least one inner cylinder.

If the at least one cylinder head has four cylinders in an in-line arrangement, examples may be advantageous in which the first cylinder group comprises the two outer cylinders and the second cylinder group comprises the two inner cylinders. Said configuration of the cylinders makes allowance, for example, for the fact that the cylinders of a four-cylinder in-line engine are generally ignited in the sequence 1-3-4-2, with the cylinders being numbered successively in series starting from an outer cylinder of the row. The proposed grouping of the cylinders ensures that the two cylinders both of the first cylinder group and also of the second cylinder group have an ignition interval of 360° CA. The two cylinders of each cylinder group therefore have the greatest possible offset with regard to their working processes.

In the case of a supercharged internal combustion engine in which the at least one cylinder head has at least four cylinders in an in-line arrangement, however, examples are also advantageous which are characterized in that each cylinder group comprises two adjacent cylinders. Such a grouping of the cylinders assists the formation of small-volume exhaust manifolds through a reduction in the line length.

Examples of the supercharged internal combustion engine are advantageous in which each cylinder has at least two outlet openings for discharging the exhaust gases, wherein each outlet opening is adjoined by an exhaust line.

During the course of the charge exchange, it is the aim for as large a flow cross section as possible to be opened up quickly in order to keep the throttling losses in the emerging gas flow as low as possible and to ensure an effective discharge of the exhaust gases. The provision of two or more outlet openings per cylinder is expedient here.

Examples of the supercharged internal combustion engine may be advantageous in which the two integrated exhaust manifolds are connected to one another. The connection of the two manifolds allows the turbine of one exhaust-gas turbocharger to be designed, using simple means, as an activatable turbine, for example by virtue of a cut-off element (e.g., valve) being arranged upstream of said turbine in the associated overall exhaust line, which cut-off element is open in the activated, that is to say switched-on state of the turbine and is closed in the deactivated, that is to say switched-off state. Such an approach would not be possible in the case of manifolds separate from one another, because this would, as a result of inadequate exhaust-gas discharging, lead to an unacceptable impairment of the charge exchange.

Accordingly, in the case of internal combustion engines whose exhaust manifolds are connected to one another, embodiments are advantageous in which the turbine of one exhaust-gas turbocharger is designed as an activatable turbine, preferably by virtue of a cut-off element being arranged upstream of the activatable turbine in the associated overall exhaust line.

Embodiments of the supercharged internal combustion engine may also be advantageous in which the activatable turbine has a variable turbine geometry. The deactivation, that is to say switching-off of the turbine is then realized by adjusting the turbine geometry in the direction of the closed position. An additional cut-off element upstream of the turbine is not required.

The turbines which are used may fundamentally be fitted with a variable turbine geometry which can be adapted by adjustment to the respective operating point of the internal combustion engine.

The turbines may also be designed as wastegate turbines, in the case of which exhaust gas is conducted via a bypass line past the turbine when the exhaust-gas mass flow exceeds a threshold value. For this purpose, a cut-off element should be provided in the bypass line.

The bypass line branches off from the first or second exhaust manifold and opens into the first or second overall exhaust line respectively or into the common line. In this context, examples of the supercharged internal combustion engine are advantageous in which the bypass line is integrated into the at least one cylinder head, wherein the realization of said example is facilitated by the projection according to the disclosure.

One option for designing the turbine of an exhaust-gas turbocharger as an activatable turbine, without the two manifolds being connected to one another, will be described below.

Specifically, examples of the supercharged internal combustion engine may be advantageous in which each cylinder has at least two outlet openings, at least one of which is designed as an activatable outlet opening, wherein the exhaust lines of the activatable outlet openings of at least two cylinders merge to form the first overall exhaust line, such that the first exhaust manifold is formed, which first overall exhaust line is connected to the turbine of the first exhaust-gas turbocharger, and the exhaust lines of the other outlet openings of the at least two cylinders merge to form the second overall exhaust line, such that the second exhaust manifold is formed, which second overall exhaust line is connected to the turbine of the second exhaust-gas turbocharger.

To design a turbine, in the present case the turbine of the first exhaust-gas turbocharger, as an activatable turbine, the exhaust lines of at least two cylinders are merged in a grouped manner such that, from each of said cylinders, at least one exhaust line leads to the turbine of the first exhaust-gas turbocharger and at least one exhaust line leads to the turbine of the second exhaust-gas turbocharger, wherein the outlet openings of the exhaust lines which lead to the first turbine are designed as activatable outlet openings. Only in the case of relatively large exhaust-gas quantities are the activatable outlet openings opened during the course of the charge exchange, and the first turbine thereby activated, that is to say acted on with exhaust gas.

The operating behavior of the internal combustion engine in the case of small exhaust-gas flows is improved considerably. Firstly, the activatable turbine is deactivated in the case of small exhaust-gas quantities, and all of the exhaust gas is conducted through the second turbine. Secondly, the line volume upstream of the second turbine, through which exhaust gas flows continuously, is decreased in size by means of this measure.

A disadvantage of the example described above is merely that the activatable turbine, in the deactivated state, is completely cut off from the exhaust-gas flow, that is to say no exhaust gas whatsoever is supplied to the deactivated turbine. This results from the use of separate exhaust manifolds, and the non-opening of the activatable outlet openings. As a result of the lack of incident exhaust-gas flow, the rotational speed of the activatable turbine decreases considerably when said turbine is deactivated. The hydrodynamic lubricating film is depleted or breaks down entirely, which increases wear and is to be regarded as a factor with regard to the susceptibility of the charger to faults.

For the reasons stated above, examples of the internal combustion engine are therefore also advantageous in which the first exhaust manifold and the second exhaust manifold are permanently connected to one another upstream of the two turbines via at least one connecting duct which cannot be closed off, wherein the smallest cross section A_{Cross,CD} of the at least one connecting duct is smaller than the smallest cross section A_{cross,Ex} of an exhaust line.

In the example in question, the manifolds are connected to one another. For this purpose, at least one connecting duct is provided which cannot be closed off, that is to say is permanently open, and which functions as an overflow duct. Said connecting duct allows some of the exhaust gas to flow over from the second exhaust manifold into the first exhaust manifold even in the case of relatively small exhaust-gas quantities, such that the activatable turbine is acted on with exhaust gas via the second manifold and connecting duct even in the deactivated, that is to say switched-off state. Here, there should be supplied to the activatable turbine via the connecting duct only such a quantity of exhaust gas that the turbine shaft does not undershoot a minimum rotational speed. Maintaining a certain minimum rotational speed prevents or reduces the depletion of the hydrodynamic lubricating film in the plain bearing of the shaft of the first charger. Furthermore, the response behavior of the activatable turbine or of the supercharging as a whole is improved, because the activatable turbine, when activated, is accelerated starting from a higher rotational speed. A torque demanded by the driver can be provided relatively quickly, that is to say with only a short delay.

Examples are therefore advantageous in which the at least one connecting duct which cannot be closed off forms a throttling point which causes a pressure reduction in the exhaust-gas flow passing through the connecting duct. In this way, it is ensured that only a small quantity of exhaust gas passes through the connecting duct, specifically precisely a quantity of exhaust gas required to maintain a certain minimum rotational speed of the turbine shaft.

The at least one connecting duct should be dimensioned in accordance with its function, that is to say should be designed to be smaller than for example the exhaust line adjoining the outlet opening, which serves to provide an adequate supply of exhaust gas to the turbine with the least possible losses.

Examples of the supercharged internal combustion engine are advantageous in which the following applies: A_{Cross,CD}≦0.3 A_{Cross,Ex}, A_{Cross,CD}≦0.2 A_{Cross,Ex}, A_{Cross,CD}≦0.1 A_{Cross,Ex}, A_{Cross,CD}≦0.05 A_{Cross,Ex}, etc.

Examples of the supercharged internal combustion engine are advantageous in which the at least one cylinder head is equipped with an integrated coolant jacket. Supercharged internal combustion engines are thermally more highly loaded than naturally aspirated engines, as a result of which greater demands are placed on the cooling system.

On account of the significantly higher heat capacity of liquids in relation to air, it is possible for significantly greater heat quantities to be dissipated by means of liquid cooling than is possible with air cooling.

Liquid cooling requires the internal combustion engine or the cylinder head to be equipped with an integrated coolant jacket, that is to say the arrangement of coolant ducts which conduct the coolant through the cylinder head. The heat is dissipated to the coolant, generally water provided with additives, already in the interior of the cylinder head. Here, the coolant is fed by means of a pump arranged in the cooling circuit, such that said coolant circulates in the coolant jacket. The heat which is dissipated to the coolant is in this way dissipated from the interior of the cylinder head and extracted from the coolant again in a heat exchanger.

Examples of the supercharged internal combustion engine are advantageous in which the projection is provided with a liquid cooling arrangement. The projection is a thermally highly loaded component. Firstly, all of the exhaust gas of the internal combustion engine passes through this accumulating point in the exhaust system, whereas for example an individual exhaust line is acted on only with the exhaust gas of one cylinder. The exhaust-gas quantity which dissipates heat to the cylinder head is consequently greatest at this location in the line system. Secondly, the projection is acted on with hot exhaust gases continuously. Furthermore, in the projection which functions as an accumulating point, owing to the principle thereof, the exhaust-gas flows of the individual exhaust lines are diverted to a greater or lesser extent. Therefore, in said region, the individual exhaust-gas flows—at least partially—have a speed component perpendicular to the walls of the exhaust-gas-conducting lines, as a result of which the heat transfer by convection and consequently the thermal loading of the projection and cylinder head is additionally increased.

In this context, examples may be advantageous in which the liquid cooling arrangement of the projection is connected to the liquid cooling arrangement of the internal combustion engine. Firstly, the already existing components of the liquid cooling arrangement of the internal combustion engine, such as heat exchanger and pump, can be utilized to convey the coolant through the projection and cool said coolant. Secondly, the common coolant warms up more quickly after a cold start, because the thermally highly loaded projection introduces additional heat into the coolant.

Turning now to FIG. 1, it schematically shows a plan view of a first embodiment of the internal combustion engine 1. Said internal combustion engine is a four-cylinder in-line engine in which the four cylinders 3a-3d are arranged along the longitudinal axis of the cylinder head 2, that is to say in a line. Each cylinder 3a-3d has two outlet openings 4 for discharging the exhaust gases, wherein each outlet opening 4 is adjoined by an exhaust line 5. As depicted in FIG. 1, the cylinders are arranged into first and second cylinder groups, 13a and 13b. Cylinder group 13a includes cylinders 3a and 3b, while cylinder group 13b includes cylinders 3c and 3d.

The exhaust lines 5 of each cylinder merge to form a component exhaust line 12 associated with the cylinder, before said component exhaust lines 12 merge within the cylinder head 2, to form two overall exhaust lines 7a, 7b, such that two integrated exhaust manifolds 6a, 6b are formed, the overall exhaust lines emerging from the cylinder head 2 on that side of the exhaust manifolds 6a, 6b which faces away from the cylinders, specifically so as to be spaced apart from one another along the longitudinal axis of the cylinder head 2. Thus, each cylinder group 13a and 13b is coupled to a respective exhaust manifold 6a, 6b.

In the embodiment illustrated in FIG. 1, in each case two adjacent cylinders form a cylinder group, the exhaust lines 5 of which are merged. The first overall exhaust line 7a of the first cylinder group 13a is connected to the inlet region 8a′ of the turbine 8a of a first exhaust-gas turbocharger, and the second overall exhaust line 7b of the second cylinder group 13b is connected to the inlet region 9a′ of the turbine 9a of a second exhaust-gas turbocharger.

The cylinder head 2 has a balcony-like projection 10, or plenum, which is arranged between the overall exhaust lines 7a, 7b emerging from the cylinder head 2 between the two turbochargers, and which, on each of the two sides which face toward a turbine 8a, 9a, has an opening which is connected to the outlet region 8e, 9e of the respective turbine 8a, 9a. The ducts which adjoin the two openings merge to form a common line within the projection 10, said common line then emerging (not illustrated) from the projection 10. In this way, exhaust from the first and second integrated manifolds can enter each turbocharger from a common direction, yet exit each turbocharger to the plenum 10 at a right angle from the common direction.

FIG. 1 shows the common direction at which the exhaust enters each turbocharger (e.g., each turbine 8a, 9a). This direction is relative to an axis of rotation of the shafts coupling the turbines to the compressors (not shown in FIG. 1). Each turbocharger includes a shaft 20, 21 which rotates around axis 22. The exhaust enters each turbocharger turbine at a common direction 24, which is perpendicular to the axis 22. The exhaust exits each turbocharger turbine a right angle from the common direction to the plenum 10. Thus, the exhaust exits the respective turbochargers at a first and second direction 26, 27 which are parallel to the axis 22. The exhaust exits the first turbine 8a in a first direction 26 to the plenum, and the exhaust exits the second turbine 9a in a second direction 27, which is opposite the first direction 26, to the plenum. While not shown in FIG. 1, the exhaust from both turbines is combined within the plenum and emerges from a common outlet in a downward direction.

Controller 112 is shown in FIG. 1 as a conventional microcomputer including a microprocessor unit, input/output ports, read-only memory, random access memory, keep alive memory, and a conventional data bus. Controller 112 may include instructions that are executable to carry out one or more control routines. Controller 112 may receive various signals from sensors coupled to engine 1, such as input from one or more temperature sensors, as well as other sensors not shown in FIG. 1. Example sensors include engine coolant temperature (ECT) from a temperature sensor, a position sensor coupled to an accelerator pedal for sensing accelerator position, a measurement of engine manifold pressure (MAP) from a pressure sensor coupled to an intake manifold of the engine, an engine position sensor from a Hall effect sensor sensing crankshaft position, a measurement of air mass entering the engine from a sensor (e.g., a hot wire air flow meter), and a measurement of throttle position. Barometric pressure may also be sensed for processing by controller 112. In a preferred aspect of the present description, an engine position sensor may produce a predetermined number of equally spaced pulses every revolution of the crankshaft from which engine speed (RPM) can be determined Controller 112 may also output signals to various actuators of the engine.

FIG. 2 schematically shows a perspective illustration of the internal combustion engine 1. It is sought merely to explain the additional features in relation to FIG. 1, for which reason reference is made otherwise to FIG. 1 and the associated description. The same reference numerals have been used for the same components.

The internal combustion engine 1 is equipped with two exhaust-gas turbochargers 8, 9 for the purpose of supercharging. Each exhaust-gas turbocharger 8, 9 comprises a turbine 8a, 9a and a compressor 8b, 8b. The hot exhaust gas expands in the turbines 8a, 9a with a release of energy, and the compressors 8b, 9b compress the charge air, which compressed charge air is supplied via intake lines to the cylinders, as a result of which supercharging of the internal combustion engine 1 is realized.

The exhaust gas emerging from the turbines 8a, 9a is accumulated in the projection 10 and is conducted onward via the common line 11 which emerges from the projection 10. In the present case, the common line 11 emerges on that side of the projection 10 which faces toward the assembly end side of the cylinder head 2, at which the cylinder head 2 can be connected to a cylinder block. A portion of the exhaust from the common line 11 may be routed to the intake of the engine 1 in a low pressure exhaust gas recirculation system (not shown).

Thus, the system of FIGS. 1 and 2 provides for an engine system comprising a first turbocharger receiving exhaust from a first cylinder group via a first integrated exhaust manifold, a second turbocharger receiving exhaust from a second cylinder group via a second integrated exhaust manifold, the first and second cylinder groups arranged in-line, and a plenum between the turbochargers, wherein exhaust enters each turbocharger from a common direction and exits each turbocharger to the plenum at a right angle from the common direction. The engine system also includes wherein the plenum includes a single exhaust outlet.

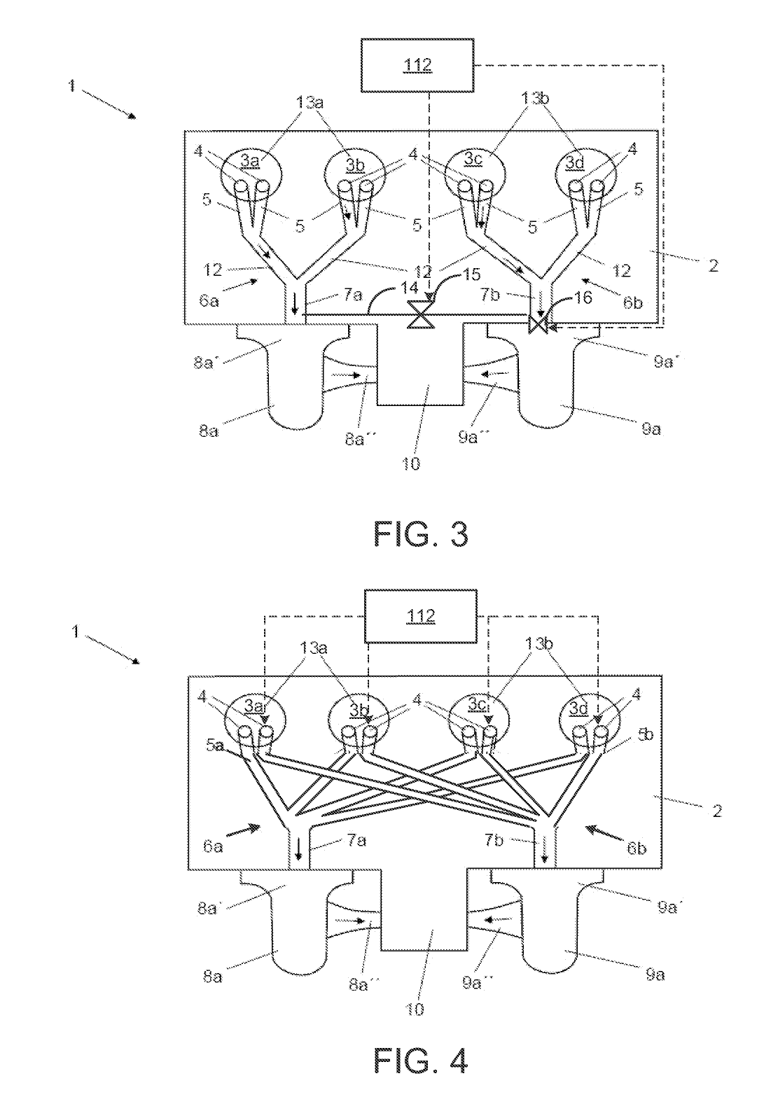

FIG. 3 schematically shows a plan view of a second embodiment of the internal combustion engine 1. The first and second exhaust manifolds 6a, 6b (e.g., overall exhaust lines 7a and 7b) are connected via a connecting line 14. A valve 15 is arranged in the connecting line 14. Further, a valve 16 is arranged between overall exhaust line 7b and the turbine 9a of the second turbocharger. Controller 112 is configured to control the position of the valves 15, 16 such that, in some conditions, all the exhaust gas from all the cylinders is routed to the turbine 8a of the first turbocharger. In other conditions, such as during increasing engine speed and load, the valves 15, 16 may be controlled such that a portion of the exhaust gas from the cylinders is routed to the turbine 8a while a portion is routed to turbine 9a.

FIG. 4 schematically shows a plan view of a third embodiment of the internal combustion engine 1. As shown, cylinders 3a-3d each includes two exhaust ports with adjoining exhaust lines, controlled via exhaust valves. Herein, for each cylinder, one exhaust line 5a is coupled to exhaust manifold 6a/overall exhaust line 7a, while the other exhaust line 5b is coupled to exhaust manifold 6b/overall exhaust line 7b. The exhaust valves for exhaust lines 5a may be controlled to open during every exhaust stroke to release exhaust gas to the first turbocharger, while the exhaust valves for exhaust lines 5b may be controlled to open during the exhaust stroke of selected operating conditions such that a portion of the exhaust gas is released to the first turbocharger and a portion of the exhaust gas is released to the second turbocharger.

FIG. 5 is a flow chart illustrating a method 500 for controlling exhaust gas. Method 500 may be carried out according to instructions stored in the memory of controller 112. Method 500 includes, at 502, determining engine operating parameters. Engine operating parameters may include engine speed, engine load, engine temperature, MAP, exhaust gas backpressure, etc. At 504, it is determined if an exhaust-gas quantity exceeds a threshold.

In a non-supercharged internal combustion engine, the exhaust-gas quantity corresponds approximately to the rotational speed and/or the load of the internal combustion engine, specifically as a function of the load control used in the individual situation. In a traditional spark-ignition engine with quantity regulation, the exhaust-gas quantity increases with increasing load even at a constant rotational speed, whereas in traditional diesel engines with quality regulation, the exhaust-gas quantity is dependent merely on rotational speed, because in the event of a load shift at constant rotational speed, the mixture composition and not the mixture quantity is varied.

If the internal combustion engine according to the disclosure is based on quantity regulation, in which the load is controlled by means of the quantity of fresh mixture, the exhaust-gas quantity may exceed the relevant, that is to say predefinable exhaust-gas quantity even at constant rotational speed if the load of the internal combustion engine exceeds a predefinable load, because the exhaust-gas quantity correlates with the load, wherein the exhaust-gas quantity rises with increasing load and falls with decreasing load.

In contrast, if the internal combustion engine is based on quality regulation, in which the load is controlled by means of the composition of the fresh mixture and the exhaust-gas quantity varies virtually exclusively with rotational speed, that is to say is proportional to the rotational speed, the exhaust-gas quantity exceeds the predefinable exhaust-gas quantity independently of the load if the rotational speed of the internal combustion engine exceeds a predefinable rotational speed.

The internal combustion engine according to the disclosure is a supercharged internal combustion engine, such that consideration may also be given to the charge pressure on the intake side, which may vary with the load and/or the rotational speed and which has an influence on the exhaust-gas quantity. The relationships discussed above regarding the exhaust-gas quantity and the load or rotational speed consequently apply only conditionally in this general form. The method according to the disclosure is therefore geared very generally to the exhaust-gas quantity and not to the load or rotational speed.

Further, in some embodiments, a portion of the exhaust downstream from the turbochargers may be routed back to the intake via an LP-EGR system. In such embodiments, the amount of exhaust directed through the LP-EGR system may impact the pressure drop across each turbocharger. Thus, the position of an LP-EGR valve may also be considered to affect the exhaust gas quantity.

If it is determined that the exhaust gas quantity does not exceed the threshold, that is if the exhaust gas quantity is small enough that routing it through one turbine, as opposed to two, will not cause excessive backpressure and/or damage to the turbine, method 500 proceeds to 506 to direct the exhaust gas to the first turbocharger. In doing so, the exhaust gas is prevented from traveling through the second turbocharger. Upon directing the exhaust gas to the first turbocharger, method 500 returns.

If it is determined that the exhaust gas quantity does exceed the threshold, method 500 proceeds to 508 to direct the exhaust to both the first and second turbochargers. In this way, a portion of the exhaust will be directed to the turbine of the first turbocharger while a portion of the exhaust gas is directed to the turbine of the second turbocharger.

Directing the exhaust to the second turbocharger may include controlling one or more upstream valves at 510, such as valve 15 of FIG. 3, which is located in a connecting line between the first and second exhaust manifolds. During engine operating when the exhaust gas quantity does not exceed the threshold, valve 15 may be open. Further, a second valve upstream of the second turbocharger, such as valve 16, may be closed so that exhaust does not reach the second turbocharger but is instead routed to the first turbocharger. When the exhaust gas quantity exceeds a threshold, the valve in the connecting line between the two exhaust manifolds may be closed while the valve in the exhaust line leading to the second turbocharger may be open. However, other valve arrangements are possible. For example, control of exhaust gas routing between the two turbochargers may be provided by a single valve.

Directing the exhaust gas to the second turbocharger may include controlling one or more cylinder exhaust valves at 512. As explained with respect to FIG. 4, each cylinder may include an exhaust line coupled to the first turbocharger and an exhaust line coupled to the second cylinder. During engine operation with exhaust gas quantity below the threshold, the cylinder exhaust valves of the exhaust lines coupled to the first turbocharger may be opened during each exhaust stroke while the cylinder exhaust valves of the exhaust lines coupled to the second turbocharger may kept closed, and as such all the exhaust in the cylinder may be released to the first turbocharger. However, when the exhaust gas quantity exceeds the threshold, the cylinder exhaust valves of the exhaust lines coupled to the second turbocharger may also be opened during each exhaust stroke so that a portion of the exhaust is directed to the second turbocharger in addition to the first turbocharger.

At 514, it is determined if the exhaust gas quantity has dropped below the threshold. If no, method 500 returns to 508 to direct the exhaust to the first and second turbochargers. If yes, method 500 proceeds to 516 to direct the exhaust gas to the first turbocharger (and not the second). Method 500 then returns.

In this way, if the exhaust-gas quantity falls below the predefinable exhaust-gas quantity again, the activatable turbine is deactivated again. Method variants are advantageous in which the activatable turbine is activated only if the exhaust-gas quantity of the internal combustion engine exceeds a predefinable exhaust-gas quantity and is greater than said first exhaust-gas quantity for a predefinable time period Δt₁.

The introduction of an additional condition for the activation of the switchable turbine is intended to prevent excessively frequent switching, in particular an activation of the activatable outlet openings, if the exhaust-gas quantity only briefly exceeds the predefinable exhaust-gas quantity and then falls again or fluctuates around the predefinable value for the exhaust-gas quantity, without the exceedance justifying an activation of the turbine.

For the reasons stated above, method variants are also advantageous in which the activatable turbine is deactivated only if the exhaust-gas quantity of the internal combustion engine falls below a predefinable exhaust-gas quantity and is lower than said first exhaust-gas quantity for a predefinable time period Δt₂.

If the turbine through which exhaust gas flows continuously is a wastegate turbine, the bypass line of which opens, downstream of the activatable turbine, into the associated exhaust manifold, examples of the method are advantageous in which the activatable turbine is accelerated shortly before activation by virtue of a cut-off element arranged in the bypass line being opened.

Thus, the method 500 of FIG. 5 provides for a method for an engine having a first and second turbocharger, comprising directing exhaust gas from the engine to the first turbocharger, and during select conditions, directing a portion of the exhaust gas to the second turbocharger. The method includes wherein the select conditions comprise high engine speed and/or load. The method also includes controlling a valve upstream of the second turbocharger during the select conditions in order to direct to the portion of exhaust gas to the second turbocharger. The method includes opening of one or more cylinder exhaust valves during the select conditions in order to direct the portion of exhaust gas to the second turbocharger.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A supercharged internal combustion engine, comprising:
a cylinder head with at least two cylinders in an in-line arrangement along a longitudinal axis of the cylinder head, each cylinder having at least one outlet opening for discharging exhaust gases, each said outlet opening being adjoined by an exhaust line;
two integrated exhaust manifolds, each including merged exhaust lines of at least one cylinder, to form first and second overall exhaust lines within the cylinder head, each overall exhaust line emerging from the cylinder head on a side of the exhaust manifolds which faces away from the cylinders, the first and second overall exhaust lines spaced apart from one another along the longitudinal axis of the cylinder head;
a first exhaust-gas turbocharger having a turbine with an inlet region connected to the first overall exhaust line;
a second exhaust-gas turbocharger having a turbine with an inlet region connected to the second overall exhaust line; and
a balcony-like projection which is arranged between the first and second overall exhaust lines emerging from the cylinder head, which on each of two sides of the projection which face towards the turbines, has an opening which is connected to an outlet region of the respective turbine, wherein ducts adjoining each opening merge to form a common line which emerges from the projection.

2. The supercharged internal combustion engine as claimed in claim 1, wherein the two overall exhaust lines which emerge from the cylinder head have a spacing L along the longitudinal axis of the cylinder head, for which the following applies: L≧D, wherein D is the diameter of a cylinder.

3. The supercharged internal combustion engine as claimed in claim 1, wherein the two overall exhaust lines which emerge from the cylinder head have a spacing L along the longitudinal axis of the cylinder head, for which the following applies: L≧1.5 D, wherein D is the diameter of a cylinder.

4. The supercharged internal combustion engine as claimed in claim 1, in which the cylinder head can be connected at an assembly end side to a cylinder block, wherein the common line which emerges from the projection emerges on a side facing toward the assembly end side.

5. The supercharged internal combustion engine as claimed in claim 1, wherein:
the at least two cylinders are configured in such a way as to form two groups with at least one cylinder in each group; and
the exhaust lines of the cylinders of each cylinder group merge, to form in each case one overall exhaust line, within the cylinder head such that an integrated exhaust manifold is formed.

6. The supercharged internal combustion engine as claimed in claim 5, in which the cylinder head has at least three cylinders in an in-line arrangement, wherein the first cylinder group comprises two outer cylinders and the second cylinder group comprises at least one inner cylinder.

7. The supercharged internal combustion engine as claimed in claim 5, in which the cylinder head has at least four cylinders in an in-line arrangement, wherein each cylinder group comprises two adjacent cylinders.

8. The supercharged internal combustion engine as claimed in claim 1, wherein each cylinder has at least two outlet openings for discharging the exhaust gases, wherein each outlet opening is adjoined by an exhaust line.

9. The supercharged internal combustion engine as claimed in claim 1, wherein the two integrated exhaust manifolds are connected to one another.

10. The supercharged internal combustion engine as claimed in claim 9, wherein a turbine of one of the two exhaust-gas turbochargers is designed as an activatable turbine.

11. The supercharged internal combustion engine as claimed in claim 10, wherein a cut-off element is arranged upstream of the activatable turbine in an associated overall exhaust line.

12. The supercharged internal combustion engine as claimed in claim 1, wherein each cylinder has at least two outlet openings, at least one of which is designed as an activatable outlet opening, wherein exhaust lines of the activatable outlet openings of at least two cylinders merge to form the first overall exhaust line, such that a first exhaust manifold of the two integrated exhaust manifolds is formed, which first overall exhaust line is connected to the turbine of the first exhaust-gas turbocharger, and exhaust lines of the other outlet openings of the at least two cylinders merge to form the second overall exhaust line, such that a second exhaust manifold of the two integrated exhaust manifolds is formed, which second overall exhaust line is connected to the turbine of the second exhaust-gas turbocharger.

13. The supercharged internal combustion engine as claimed in claim 12, wherein the first exhaust manifold and the second exhaust manifold are permanently connected to one another upstream of the two turbines via at least one connecting duct which cannot be closed off, wherein a smallest cross section A_{Cross,CD} of the at least one connecting duct is smaller than a smallest cross section A_{Cross,Ex} of an exhaust line.

14. The supercharged internal combustion engine as claimed in claim 1, wherein the projection is provided with a liquid cooling arrangement.

15. The supercharged internal combustion engine as claimed in claim 1, wherein a turbine of one of the two exhaust-gas turbochargers is designed as an activatable turbine, and further comprising a controller including instructions to activate the activatable turbine when an exhaust-gas quantity exceeds a predefinable exhaust-gas quantity.

16. An engine system, comprising:
a first turbocharger receiving exhaust from a first cylinder group via a first integrated exhaust manifold;
a second turbocharger receiving exhaust from a second cylinder group via a second integrated exhaust manifold, the first and second cylinder groups arranged in-line; and
a plenum between the turbochargers, wherein exhaust enters each turbocharger from a common direction and exits each turbocharger to the plenum at a right angle from the common direction.

17. The engine system of claim 16, wherein the plenum includes a single exhaust outlet.

18. A method for an engine having a first and second turbocharger, comprising:
directing exhaust gas from the engine to the first turbocharger via an integrated exhaust manifold; and
during select conditions, directing only a portion of the exhaust gas to the second turbocharger.

19. The method of claim 18, wherein the select conditions comprise high engine speed and/or load, and further comprising controlling a valve upstream of the second turbocharger during the select conditions in order to direct the portion of exhaust gas to the second turbocharger.

20. The method of claim 18, further comprising opening of one or more cylinder exhaust valves during the select conditions in order to direct the portion of exhaust gas to the second turbocharger.
